(19) United States
(12) Patent Application Publication
(10) Pub. No.: US 2025/0012756 A1
(43) Pub. Date: Jan. 9, 2025

(54) SENSOR SYSTEM

(71) Applicant: ROHM CO., LTD., Kyoto-shi (JP)

(72) Inventors: Shunsuke AKASAKA, Kyoto shi (JP); Koji TERUMOTO, Kyoto shi (JP)

(21) Appl. No.: 18/894,902

(22) Filed: Sep. 24, 2024

Related U.S. Application Data
(63) Continuation of application No. PCT/JP2023/000066, filed on Jan. 5, 2023.

(30) Foreign Application Priority Data
Mar. 25, 2022 (JP) 2022-049943

(51) Int. Cl. G01N 27/409; G01N 27/407; G01N 27/416

(52) U.S. Cl. CPC G01N 27/409; G01N 27/4073; G01N 27/4163

(57) ABSTRACT

A sensor system includes a sensor of a limiting current type that detects an oxygen concentration, and a control device. The control device includes a storage that stores a calibration curve indicating relation between a voltage applied to the sensor and an oxygen ion current, the relation being changed according to the oxygen concentration. The control device is configured to measure the oxygen concentration by applying, to the sensor, a voltage based on the calibration curve and a detection value obtained by performing application of a voltage to the sensor.

### TECHNICAL FIELD

The present disclosure relates to a sensor system.

### BACKGROUND ART

Japanese Patent Laying-Open No. 2021-124473 (PTL 1) discloses a limiting current-type oxygen sensor that can measure an oxygen concentration and a humidity. It is known that an oxygen sensor of a limiting current type can measure an oxygen concentration at a limiting current value at which a current is saturated with respect to an applied voltage.

### CITATION LIST

### Patent Literature

PTL 1: Japanese Patent Laying-Open No. 2021-124473

### BRIEF DESCRIPTION OF DRAWINGS

FIG. 1 is a view showing a hardware configuration of a sensor system in accordance with an embodiment.

FIG. 2 is a view showing the relation between an applied voltage and an oxygen ion current.

FIG. 3 is a view showing the relation between the applied voltage and the oxygen ion current in a case where an oxygen concentration is less than or equal to 8%.

FIG. 4 is a view showing a rising voltage of the oxygen ion current due to water vapor.

FIG. 5 is a flowchart showing processing for measuring the oxygen concentration in the sensor system.

FIG. 6 is a view showing first to third voltages added to calibration curves in FIG. 3.

FIG. 7 is a view showing the relation between an oxygen concentration and an oxygen ion current in a sensor system in accordance with a comparative example.

FIG. 8 is a view showing the relation between the oxygen concentration and the oxygen ion current in the sensor system in accordance with the embodiment.

### DESCRIPTION OF EMBODIMENTS

Hereinafter, an embodiment of the present invention will be described in detail with reference to the drawings. It should be noted that identical or corresponding parts in the drawings will be designated by the same reference numerals, and the description thereof will not be repeated.

### [1. Configuration of Sensor System]

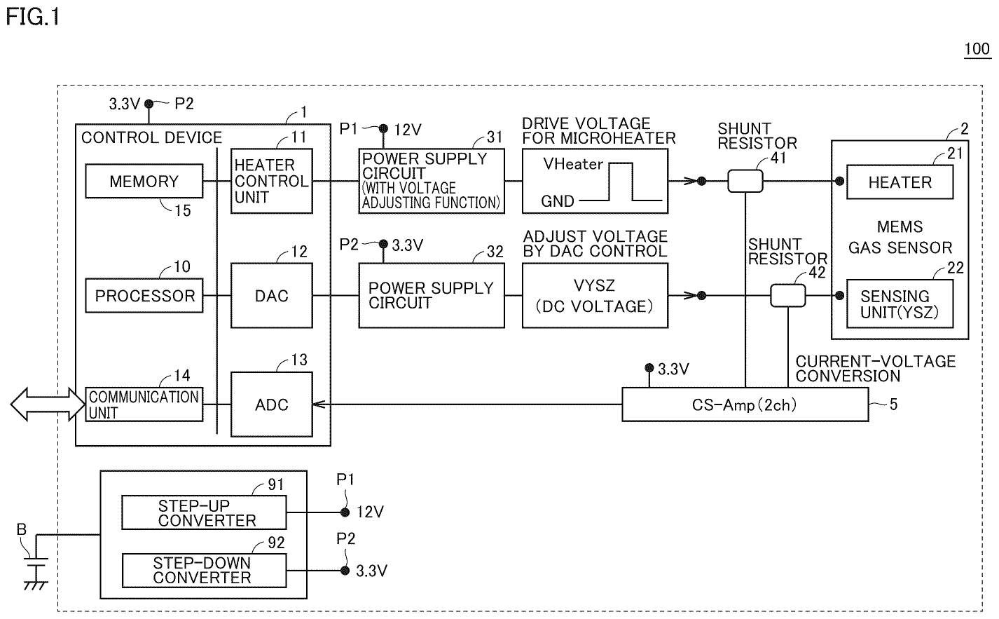

FIG. 1 is a schematic view showing a configuration of a sensor system 100 in accordance with an embodiment of the present invention. Referring to FIG. 1, sensor system 100 includes a control device 1, a sensor 2, an amplifier 5, power supply circuits 31 and 32, resistors 41 and 42, a step-up converter 91, and a step-down converter 92.

Sensor 2 is a sensor of a limiting current type that can measure an oxygen concentration. Sensor 2 is a small-sized limiting current-type microelectromechanical system (MEMS) sensor, for example, and is composed by mounting a sensing unit, a mechanical element component, an electronic circuit, and the like on a substrate (not shown). In one embodiment, sensor 2 is an yttria-stabilized zirconia (YSZ)-type sensor, and includes a heater 21 and a sensing unit 22.

Heater 21 converts power supplied from power supply circuit 31 into heat, and heats sensing unit 22. For example, heater 21 is a ultra-high temperature microheater, and heats sensing unit 22 to a high temperature (for example, more than or equal to 500 degrees).

Sensing unit 22 is a sensing unit of a limiting current type, and is composed of a solid electrolyte and an electrode. The solid electrolyte includes at least one of yttria, scandium, ytterbium, erbium, dysprosium, gadolinium, and lanthanum, for example. In one embodiment, the solid electrolyte is a YSZ thin film. The electrode is porous Pt, for example. When a predetermined voltage is applied from power supply circuit 32 to the sensing unit, an oxygen ion current according to the oxygen concentration is generated. In the present specification, the oxygen ion current may simply be referred to as a “current”. Further, a value of the oxygen ion current may simply be referred to as a “current value”. The oxygen ion current may exhibit a saturation phenomenon that the current becomes almost constant even though an applied voltage increases. The current which becomes almost constant is called a limiting current. In an oxygen sensor of a limiting current type, an oxygen concentration is generally measured based on the limiting current.

Sensor system 100 receives power from a battery B. Battery B is a lithium ion battery that applies a voltage of 3.6 V to 4.2 V, for example.

Step-up converter 91 steps up a voltage applied from battery B to a predetermined voltage P1. Predetermined voltage P1 is 12 V, for example. Voltage P1 is applied to power supply circuit 31, for example.

Step-down converter 92 is a linear regulator called a Low Dropout (LDO), for example. Step-down converter 92 steps down the voltage applied from battery B to a predetermined voltage P2. Predetermined voltage P2 is 3.3 V, for example. Voltage P2 is applied to control device 1 and power supply circuit 32, for example.

Power supply circuit 31 adjusts a voltage to be applied to heater 21 based on control by control device 1. The voltage is also referred to as a drive voltage for the microheater. Specifically, power supply circuit 31 converts constant voltage P1 applied via step-up converter 91 into a periodic pulse waveform by pulse width modulation (PWM) or Port control. The Port control is to control ON/OFF of power supply circuit 31 using an output terminal of control device 1.

Power supply circuit 32 adjusts a voltage to be applied to sensing unit 22 based on control by control device 1. Specifically, power supply circuit 32 adjusts voltage P2 applied via step-down converter 92 to a predetermined voltage.

Resistor 41 is a shunt resistance, and the value of a current flowing between power supply circuit 31 and heater 21 is measured by a voltage drop by the shunt resistor.

Resistor 42 is a shunt resistance, and the value of a current flowing between power supply circuit 32 and sensing unit 22 is measured by a voltage drop by the shunt resistor.

Amplifier 5 is an amplifier for amplification, and amplifies a potential difference by the voltage drops in resistors 41 and 42 and transmits it to control device 1.

Control device 1 is a microcomputer, for example. Control device 1 includes a processor 10, a heater control unit 11, a digital analog converter (D/A converter: DAC) 12, an analog digital converter (A/D converter: ADC) 13, a communication unit 14, and a memory 15 which are connected with one another by a common bus.

Processor 10 includes a central processing unit (CPU), for example. Processor 10 loads a program stored in memory 15 into a RAM or the like and executes the program.

Memory 15 is implemented by a non-volatile memory such as a random access memory (RAM), a read only memory (ROM), and a flash memory. Memory 15 stores a program to be executed by processor 10, data to be used by processor 10, or the like.

Heater control unit 11 controls power supply circuit 31 to adjust the voltage to be applied to heater 21. Heater control unit 11 controls power supply circuit 31 using the PWM or Port control.

D/A converter 12 converts a digital signal of control device 1 into an analog signal, and outputs the analog signal to power supply circuit 32.

A/D converter 13 converts an analog signal indicating a voltage drop amount in shunt resistors 41 and 42 inputted from amplifier 5 into a digital signal, and inputs the digital signal to control device 1. The voltage drop amount converted into the digital signal by A/D converter 13 is converted into a current value by processor 10. Processor 10 measures an oxygen concentration based on the current value.

Communication unit 14 performs communication between sensor system 100 and an external device. Communication unit 14 is an Inter Integrated Circuit (I2C) serial bus, for example. Communication unit 14 is used, for example, to transmit the oxygen concentration measured in sensor system 100 to the external device.

It should be noted that a display unit, an audio output unit, or the like (not shown) may be provided to sensor system 100, and may be used to notify the external device of the measured oxygen concentration or the like.

With a configuration as described above, control device 1 of sensor system 100 in accordance with the embodiment measures the oxygen concentration based on a current value obtained by performing application of a voltage to sensor 2. Memory 15 stores a later-described calibration curve indicating the relation between a voltage applied to sensor 2 and an oxygen ion current, the relation being changed according to the oxygen concentration. Control device 1 measures the oxygen concentration based on the calibration curve and a detection value. It should be noted that, in the present specification, the detection value is a current value generated in sensor 2, or an oxygen concentration calculated in control device 1 based on the current value.

### [2. Influence of Humidity in Limiting Current-Type Sensor]

In the oxygen sensor of a limiting current type, the oxygen concentration is generally measured based on the limiting current. However, in an environment with a low oxygen concentration, there occurs a phenomenon that a voltage for electrolysis of water vapor decreases. Thereby, in a situation with a high humidity, water vapor has a larger influence, causing an increase in current value. That is, depending on the oxygen concentration and the humidity in the environment, it may be not possible to accurately measure the oxygen concentration based on the current value.

Accordingly, in sensor system 100 in accordance with the present embodiment, the oxygen concentration is measured using a calibration curve indicating the relation between a voltage applied to the sensor and an oxygen ion current according to the oxygen concentration. More specifically, the oxygen concentration is measured by applying, to the sensor, a voltage based on the calibration curve and a detection value obtained by performing application of a voltage to sensor 2. Thereby, an accurate oxygen concentration can be measured regardless of the oxygen concentration and the humidity. Therefore, the accuracy of measuring the oxygen concentration is improved. In the following, the calibration curve used in sensor system 100 will be described for each of a case where the oxygen concentration is relatively high and a case where the oxygen concentration is relatively low.

[3. Calibration Curve in Sensor System in Accordance with Embodiment]
(3-1. Calibration Curve in Case where Oxygen Concentration is High)

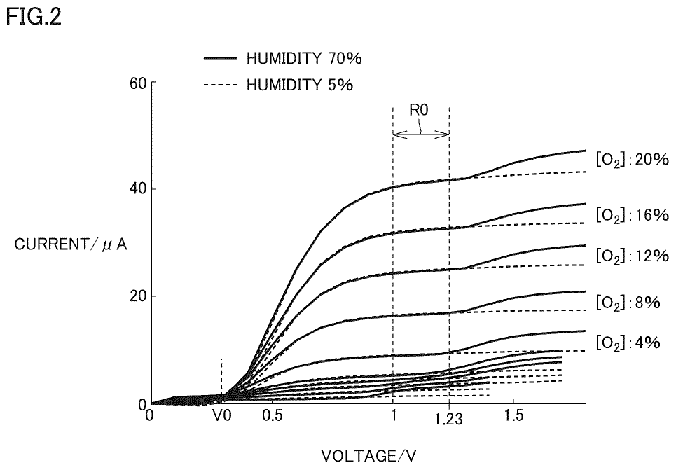

FIG. 2 is a view showing the relation between an applied voltage and an oxygen ion current. In FIG. 2, the axis of abscissa represents the voltage (V), and the axis of ordinate represents the oxygen ion current (μA).

More specifically, FIG. 2 shows values of the oxygen ion current with respect to the voltage applied to sensor 2 in the case of changing the oxygen concentration and the humidity. In the following description, a graph indicating the relation between a voltage applied to the sensor and an oxygen ion current as shown in FIG. 2 is also referred to as a “calibration curve”. A solid line indicates a value in a case where the humidity is relatively high (70%), and a broken line indicates a value in a case where the humidity is relatively low (5%). Cases where the oxygen concentration is less than or equal to 20% are shown. In FIG. 2, a description will be given while particularly paying attention to calibration curves in the case where the oxygen concentration is relatively high (4% to 20%).

First, a change in current value in the case where the humidity is low will be described. In sensor 2, a current is generated when the applied voltage becomes equal to or more than a predetermined voltage V0. In FIG. 2, voltage V0 at which the current is generated is about 0.2 to 0.3 V.

Thereafter, the current value increases according to the voltage, but it increases gradually slowly and then becomes nearly flat. In other words, there occurs a saturation phenomenon that the current becomes almost constant even though the voltage increases. As a result, the current value exhibits a stable value even though the voltage fluctuates more or less. The current is called a limiting current, as described above. FIG. 2 shows that the limiting current is generated when a voltage larger than about 1.0 V is applied, for example.

Next, a change in current value in the case where the humidity is relatively high will be described. Also in the case where the humidity is high, the change in current value is almost the same as that in the case where the humidity is low, with respect to a voltage before the limiting current is generated, and a voltage up to a predetermined voltage (about 1.23 V) after the limiting current is generated. However, when the applied voltage becomes equal to or more than the predetermined voltage, the increase rate of the current value with respect to the voltage increases again. Therefore, even when the same voltage as that in the case where the humidity is low is applied, the current value becomes higher than that in the case where the humidity is low. In the present specification, a voltage at which the graph begins to rise due to a high humidity is also referred to as a “rising voltage”. In FIG. 2, the rising voltage is about 1.23 V.

In other words, in the case where the oxygen concentration is 4% to 20%, when the applied voltage is less than the rising voltage, a current according to the voltage is generated regardless of the humidity. On the other hand, when the applied voltage is more than or equal to the rising voltage, the current value rises in the case where the humidity is high, and the current value becomes higher than that in the case where the humidity is low.

That is, in the case where the oxygen concentration is 4% to 20%, when a voltage included in a section that is more than or equal to a voltage at which the limiting current is generated and less than the rising voltage is applied, the oxygen concentration can be accurately measured regardless of the humidity. In the present specification, the “section that is more than or equal to a voltage at which the limiting current is generated and less than the rising voltage” is referred to as a “specific section”. In FIG. 2, the specific section is a section R0 between 1.0 V and 1.23 V, for example.

(3-2. Calibration Curve in Case where Oxygen Concentration is Low)

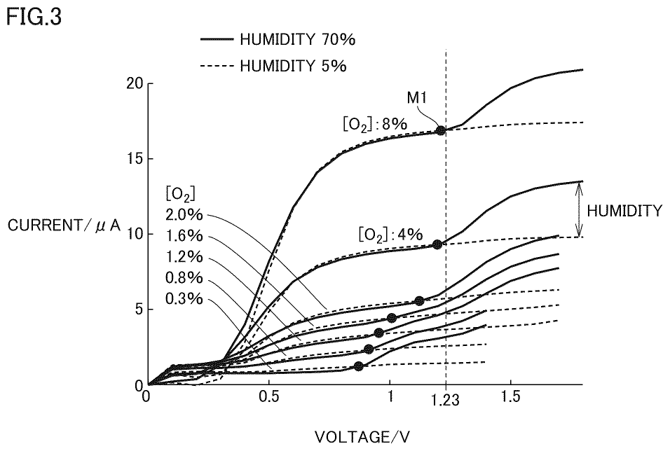

FIG. 3 is a view (calibration curves) showing the relation between the applied voltage and the oxygen ion current in a case where the oxygen concentration is less than or equal to 8%. In FIG. 3, the axis of abscissa represents the voltage (V), and the axis of ordinate represents the oxygen ion current (μA). A symbol M1 in FIG. 3 indicates a rising voltage in a case where the oxygen concentration is 0.3 to 8.0%. In FIG. 3, a description will be given while particularly paying attention to calibration curves in the case where the oxygen concentration is relatively low (less than 4.0%).

Referring to FIG. 3, as the oxygen concentration is lower, the rising voltage of the current value becomes lower. In the example in FIG. 3, in a case where the oxygen concentration is less than a predetermined value (4.0% in FIG. 3), the rising voltage gradually becomes lower than about 1.23 V in the case where the oxygen concentration is high, and the rising voltage becomes less than about 0.8 V in a case where the oxygen concentration is less than 1.0%.

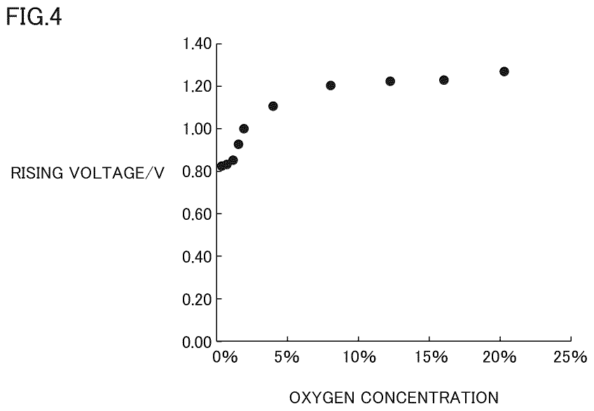

FIG. 4 is a view showing the rising voltage of the oxygen ion current due to water vapor. In FIG. 4, the axis of abscissa represents the oxygen concentration (%), and the axis of ordinate represents the rising voltage (V). Referring to FIG. 4, in a case where the oxygen concentration is less than 4.0%, the rising voltage decreases relatively significantly, when compared with a case where the oxygen concentration is more than or equal to 4.0%.

That is, in the case where oxygen concentration is low (less than about 4.0%), even if a predetermined voltage (for example, 1.1 V) included in the specific section, which is less likely to be influenced by the humidity and is desirable to measure an accurate oxygen concentration in the case where the oxygen concentration is high (about 4.0% to 20%), is applied, the detected current value is significantly influenced by the humidity. Thus, in the case where the oxygen concentration is low, it may be not possible to accurately measure the oxygen concentration, even though the same voltage as that in the case where the oxygen concentration is high is applied. Accordingly, in sensor system 100 in accordance with the present embodiment, the oxygen concentration is measured with high accuracy by changing the applied voltage according to the oxygen concentration, based on a calibration curve.

[4. Flow of Processing by Sensor System in Accordance with Embodiment]

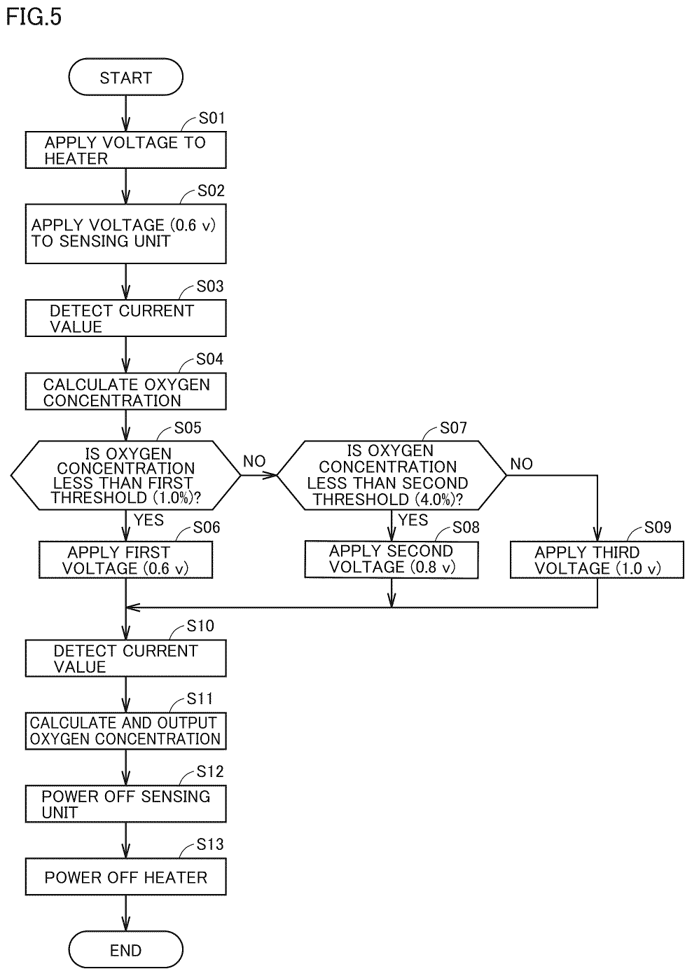

FIG. 5 is a flowchart showing processing for measuring the oxygen concentration in sensor system 100. Each step shown in FIG. 5 is performed by sensor system 100 after entire sensor system 100 is powered on.

In step (hereinafter, a step will be abbreviated as “S”) 01, control device 1 applies a voltage to heater 21. The voltage is a pulsed voltage, for example.

In S02, control device 1 applies a voltage to sensing unit 22. The voltage is 0.6 V, for example.

In S03, control device 1 detects a current value generated in sensing unit 22.

In S04, control device 1 calculates an oxygen concentration based on the current value. In S04, more specifically, an approximate number of an actual oxygen concentration is measured (described in detail later).

In S05, control device 1 determines whether or not the oxygen concentration is less than a first threshold. The first threshold is 1.0%, for example.

When the oxygen concentration is less than the first threshold (YES in S05), in S06, control device 1 applies a first voltage to sensing unit 22. The first voltage is 0.6 V, for example.

When the oxygen concentration is more than or equal to the first threshold (NO in S05), in S07, control device 1 determines whether or not the oxygen concentration is less than a second threshold. The second threshold is 4.0%, for example.

When the oxygen concentration is less than the second threshold (YES in S07), in S08, control device 1 applies a second voltage to sensing unit 22. The second voltage is 0.8 V, for example.

When the oxygen concentration is more than or equal to the second threshold (NO in S07), in S09, control device 1 applies a third voltage to sensing unit 22. The third voltage is 1.0 V, for example. It should be noted that, as described later, values of the first threshold, the second threshold, and the first to third voltages are set based on a calibration curve stored in memory 15.

Subsequent to any one step of S06, S08, and S09, in S10, control device 1 detects a current value generated in sensing unit 22.

In S11, control device 1 calculates an oxygen concentration based on the current value, and outputs it. In S11, more specifically, the actual oxygen concentration is measured with high accuracy (described in detail later). Outputting of the oxygen concentration is performed by transmitting the oxygen concentration to an external device such as a computer or a tablet terminal, using communication unit 14, for example. The external device displays the oxygen concentration using a display device such as a display, for example.

In S12, control device 1 powers off sensing unit 22.

In S13, control device 1 powers off heater 21, and ends the processing. Sensor system 100 itself is appropriately powered off automatically or by a user.

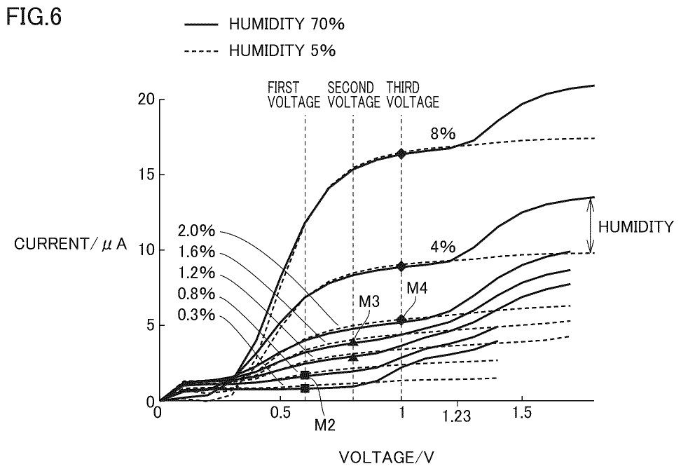

FIG. 6 is a graph showing the first to third voltages shown in FIG. 5 with respect to the calibration curves shown in FIG. 3. Referring to FIG. 6, a symbol M2 indicates a point corresponding to the first voltage on a calibration curve in the case where the oxygen concentration is less than 1.0%. A symbol M3 indicates a point corresponding to the second voltage on a calibration curve in a case where the oxygen concentration is more than or equal to 1.0% and less than 4.0%. A symbol M4 indicates a point corresponding to the third voltage on a calibration curve in the case where the oxygen concentration is more than or equal to 4.0%.

Referring to FIGS. 5 and 6, in sensor system 100, a voltage in the specific section described above is applied in each of the case where the oxygen concentration is less than 1.0%, the case where the oxygen concentration is more than or equal to 1.0% and less than 4.0%, and the case where the oxygen concentration is more than or equal to 4.0%. That is, by using the first threshold, the second threshold, and the first to third voltages as shown in FIG. 5, the oxygen concentration can be measured accurately and without being influenced by the humidity.

[5. Comparison of Detection Values of Sensor Systems Respectively in Accordance with Comparative Example and Embodiment]

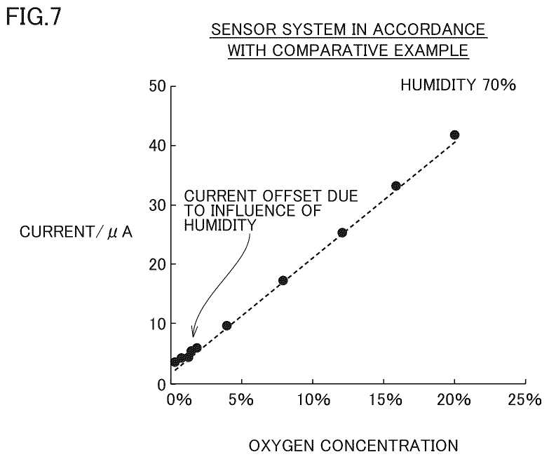

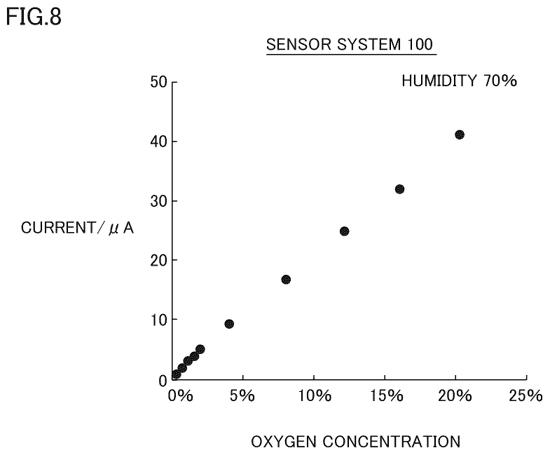

Next, measurement accuracy in sensor system 100 will be described using FIGS. 7 and 8.

(5-1. Current Value in Sensor System in Accordance with Comparative Example)

FIG. 7 is a view showing the relation between an oxygen concentration and an oxygen ion current in a sensor system in accordance with a comparative example. In FIG. 7, the axis of abscissa represents an actual oxygen concentration (%) in an environment, and the axis of ordinate represents a current value (μA). FIG. 7 is a graph that plots current values obtained by applying a predetermined voltage (for example, about 1.1 V, see FIG. 2) included in specific section R1 in the case where the oxygen concentration is 4% to 20%, in each of a plurality of oxygen concentrations between 0.3% and 20% shown in FIGS. 2 and 3, when the humidity is 70%.

When a current value generated in sensor 2 corresponds to the actual oxygen concentration, the graph should ideally be a straight line passing through the origin. However, in the example in FIG. 7, a phenomenon that the graph has a smaller gradient is exhibited when the oxygen concentration is low (less than about 4.0%). The phenomenon is also referred to as a “current offset due to the influence of the humidity”. The current offset reflects that rising of the current value due to water vapor at a low oxygen concentration occurs at less than the predetermined voltage included in specific section R1 described above (see FIG. 2).

Since the detected current value does not correspond to the actual oxygen concentration, it is difficult in the sensor system in accordance with the comparative example to measure an accurate oxygen concentration in a region at a low oxygen concentration.

(5-2. Current Value in Sensor System in Accordance with Embodiment)

In contrast, FIG. 8 is a view showing the relation between the oxygen concentration and the oxygen ion current in sensor system 100 in accordance with the present embodiment. In FIG. 8, the axis of abscissa represents an actual oxygen concentration (%) in an environment, and the axis of ordinate represents a current value (μA). FIG. 8 is a graph that plots current values obtained by applying a voltage set based on a first detection value and a calibration curve, the first detection value being an oxygen concentration obtained by applying a predetermined voltage (for example, about 1.1 V, see FIG. 2) included in specific section R1 in the case where the oxygen concentration is 4% to 20%, in each of the plurality of oxygen concentrations between 0.3% and 20% shown in FIGS. 2 and 3, when the humidity is 70%.

In FIG. 8, a current offset due to the influence of the humidity exhibited in FIG. 7 does not occur, and the graph is a straight line passing through the origin. That is, the graph reflects that, in voltage application for a second time, a voltage which is not influenced by water vapor even at a low oxygen concentration and at which the limiting current is generated is applied (see FIG. 6).

That is, since the detected current value corresponds to the actual oxygen concentration, it is possible in sensor system 100 in accordance with the present embodiment to measure an accurate oxygen concentration even at a low oxygen concentration, regardless of the humidity. Thus, the accuracy of measuring the oxygen concentration can be improved by sensor system 100.

It should be noted that, since the accuracy of measuring the oxygen concentration can be improved as described above, the accuracy of measuring the humidity based on measurement of oxygen concentration is also improved in sensor system 100.

[6. Further Description of Sensor System in Accordance with Embodiment]

As described above, in sensor system 100, the oxygen concentration is measured by applying a voltage based on a calibration curve and an oxygen concentration measured based on a current value detected by sensor 2. With such a configuration, an appropriate applied voltage based on the oxygen concentration and the calibration curve can be applied to sensor 2. Thus, an accurate oxygen concentration can be measured even at a low oxygen concentration, without being influenced by the humidity, when compared with a case where a constant voltage (for example, 1.1 V) is applied regardless of the oxygen concentration and the calibration curve. Therefore, the accuracy of measuring the oxygen concentration can be improved in sensor system 100. It should be noted that the oxygen concentration may be measured by setting a voltage to be applied based on a current value and a calibration curve, instead of an oxygen concentration and a calibration curve. Also in this case, the oxygen concentration can be measured in the same way with high accuracy.

It should be noted that, when sensor 2 is a sensor in which the relation between the voltage applied to sensor 2 and the oxygen ion current changes under the influence of the humidity as illustrated above, a calibration curve including the influence of the humidity is used. Thereby, also for the sensor influenced by the humidity, a voltage which is less likely to be influenced by the humidity can be applied based on the calibration curve. That is, also in a sensor system using the sensor influenced by the humidity, the oxygen concentration can be measured with high accuracy. However, also in a sensor system including a sensor which is likely to be influenced by a condition in an environment that is different from the humidity, the oxygen concentration can be measured with high accuracy by incorporating sensor system 100 to apply a voltage which is less likely to be influenced by the condition.

In sensor system 100, control device 1 sets, based on a first detection value obtained by performing the application of the voltage to sensor 2 for a first time, the voltage to be applied to sensor 2 for a second time. Then, control device 1 measures the oxygen concentration based on a second detection value obtained by performing application for the second time. Thereby, it is possible to apply a voltage at which the oxygen concentration can be measured accurately, according to the oxygen concentration obtained based on the first detection value. Thus, the oxygen concentration can be measured with high accuracy.

A voltage at which it is estimated that the oxygen ion current during application is not influenced by the humidity regardless of the oxygen concentration is set as the voltage to be applied for the first time, based on the calibration curve. Specifically, a voltage less than a rising voltage even in the case where the oxygen concentration is low is applied. In one embodiment, a voltage less than a rising voltage (about 0.8 V) in a case where the oxygen concentration is 0.3% is applied (see FIGS. 3 and 4), and for example, as illustrated in FIG. 5, a voltage of 0.6 V is applied.

A voltage included in the specific section described above is set as the voltage to be applied for the second time, based on the first detection value and the calibration curve. As the voltage included in the specific section described above, for example, a voltage at which a current value appears nearly flat may be selected, or a voltage at which the amount of change of a current value with respect to the voltage is less than or equal to a predetermined threshold may be selected, in the calibration curve for each oxygen concentration shown in FIGS. 2 and 3, when the humidity is relatively high (70%).

With such a configuration, in the application for the first time, a voltage which is not influenced by the humidity regardless of the oxygen concentration is applied, and thereby the approximate number of the oxygen concentration can be measured regardless of the oxygen concentration and the humidity in the environment. Further, in the application for the second time, a voltage at which it is estimated that the oxygen ion current during application is not influenced by the humidity and reaches a limiting current is applied according to the first detection value, and thereby an accurate oxygen concentration which is less likely to be influenced by the humidity is obtained.

In one embodiment, the voltage to be applied for the second time is selected from a plurality of stepwise voltages. Control device 1 selects the voltage to be applied for the second time from the plurality of stepwise voltages, based on the calibration curve and the detection value obtained in the application for the first time. With such a configuration, control device 1 can select an appropriate voltage based on the oxygen concentration from the plurality of stepwise voltages, and can appropriately measure the oxygen concentration. More specifically, based on the approximate number of the oxygen concentration obtained in the application for the first time, a voltage at which it is estimated that the oxygen ion current is not influenced by the humidity and reaches a limiting current at that oxygen concentration can be selected and applied. Thereby, the oxygen concentration is obtained accurately and regardless of the humidity.

However, the manner of the application for the second time is not limited thereto, and for example, a manner of steplessly setting the voltage for the second time from the detection value in the application for the first time based on the calibration curve may be adopted. For example, a manner of approximating the relation between the oxygen concentration and the rising voltage shown in FIG. 4 using a polynomial, and applying a voltage immediately before the rising voltage based on the polynomial may be adopted. However, in this case, it is necessary to steplessly control the voltage to be applied to sensor 2, which requires a complicated control. FIGS. 5 and 6 show that, by applying any of the voltages in three steps according to the oxygen concentration in the application for the second time, a sufficiently accurate oxygen concentration can be measured with a simple control.

As described above, in sensor system 100 in accordance with the present embodiment, control device 1 measures the oxygen concentration based on a calibration curve and a detection value obtained by performing application of a voltage to sensor 2. Thereby, an accurate oxygen concentration can be measured under a condition indicating an appropriate detection value selected based on the calibration curve and the detection value. Thus, the accuracy of measuring an oxygen concentration can be improved in a sensor system including a sensor of a limiting current type.

It should be understood that the embodiment disclosed herein is illustrative and non-restrictive in every respect. The scope of the present invention is defined by the scope of the claims, rather than the description above, and is intended to include any modifications within the scope and meaning equivalent to the scope of the claims.

### REFERENCE SIGNS LIST

1: control device; 2: sensor; 5: amplifier; 10: processor; 11: heater control unit; 12: D/A converter; 13: A/D converter; 14: communication unit; 15: memory; 21: heater; 22: sensing unit; 31, 32: power supply circuit; 41, 42: resistor; 91: step-up converter; 92: step-down converter; 100: sensor system; B: battery.

1. A sensor system comprising:
a sensor of a limiting current type that detects an oxygen concentration; and
a control device including a storage that stores a calibration curve indicating relation between a voltage applied to the sensor and an oxygen ion current, the relation being changed according to the oxygen concentration, wherein
the control device is configured to measure the oxygen concentration by applying, to the sensor, a voltage based on the calibration curve and a detection value obtained by performing application of a voltage to the sensor.

2. The sensor system according to claim 1, wherein the detection value is a current value detected by the sensor, or an oxygen concentration calculated based on the current value.

3. The sensor system according to claim 2, wherein
the control device is configured to
set, based on a first detection value obtained by performing the application of the voltage to the sensor for a first time, the voltage to be applied to the sensor for a second time, and
measure the oxygen concentration based on a second detection value obtained by performing application for the second time.

4. The sensor system according to claim 3, wherein
the sensor is a sensor in which the relation between the voltage applied to the sensor and the oxygen ion current changes under influence of humidity, and
the calibration curve includes the influence of the humidity.

5. The sensor system according to claim 4, wherein a voltage at which it is estimated that the oxygen ion current during application is not influenced by the humidity regardless of the oxygen concentration is set as the voltage to be applied for the first time, based on the calibration curve.

6. The sensor system according to claim 4, wherein a voltage at which it is estimated that the oxygen ion current during application is not influenced by the humidity and reaches a limiting current is set as the voltage to be applied for the second time, based on the first detection value and the calibration curve.

7. The sensor system according to claim 6, wherein
the voltage to be applied for the second time is selected from a plurality of stepwise voltages, and
the control device is configured to select the voltage to be applied for the second time from the plurality of stepwise voltages, based on the calibration curve and the detection value obtained in the application for the first time.

8. The sensor system according to claim 7, wherein
the plurality of stepwise voltages include a first voltage to a third voltage, and
the control device is configured to apply to the sensor, as the voltage to be applied for the second time,
the first voltage when the detection value is less than a first threshold,
the second voltage when the detection value is more than or equal to the first threshold and less than a second threshold, and
the third voltage when the detection value is more than or equal to the second threshold.

9. The sensor system according to claim 8, wherein
the first and second thresholds are 1.0% and 4.0%, respectively, and
the first, second, and third voltages are 0.6 V, 0.8 V, and 1.0 V, respectively.

10. The sensor system according to claim 1, wherein
the sensor includes a metal as a solid electrolyte, and
at least one of yttria, scandium, ytterbium, erbium, dysprosium, gadolinium, and lanthanum is used as the metal.

11. The sensor system according to claim 1, wherein the sensor is an yttria-stabilized zirconia-type sensor.
